(19) United States
(12) Patent Application Publication
(10) Pub. No.: US 2019/0251573 A1
(43) Pub. Date: Aug. 15, 2019

(54) SYSTEMS AND METHODS OF VERIFYING CREDENTIALS OF AIRCRAFT PERSONNEL USING A BLOCKCHAIN COMPUTER SYSTEM

(71) Applicants: Airbus (S.A.S.), Blagnac (FR); Airbus Operations Limited, Bristol (GB)

(72) Inventors: Masatake TOYOTA, Bristol (GB); Laurent PEIRONE, Toulouse (FR)

(21) Appl. No.: 15/893,166

(22) Filed: Feb. 9, 2018

(51) Int. Cl. G06Q 30/00; H04L 9/32

(52) U.S. Cl. CPC G06Q 30/018; H04L 9/3247; G06Q 50/2057; H04L 2209/38; H04L 9/3236

(57) ABSTRACT

A system is provided that includes a blockchain computer system, an issuer computer system, and a verifier computer system. Different nodes of the blockchain computer system are associated with the issuer and verifier computer systems. The issuer computer system and the node of the blockchain computer system associated therewith generate and submit blockchain transactions that contain data for aircraft personnel certifications. The aircraft personnel certifications are stored on the blockchain and may be later retrieved by the verifier computer system and its associated node of the blockchain computer system. Accordingly, the certifications of aircraft personnel can be maintained and verified. The system ensures the digital certifications are authentic and have not been tampered with.

### TECHNICAL OVERVIEW

The technology herein relates to systems and methods of recording, verifying and/or authenticating credentials or certifications of airplane flight and maintenance crew. More particularly, the technology described herein relates to techniques that operate without reliance on a trusted third party by allowing parties to interface with a distributed ledger or blockchain.

### INTRODUCTION AND SUMMARY

Frank Abagnale, played by Leonardo DiCaprio in the film “Catch Me If You Can”, faked being a Pan American World Airways pilot for several years. His success stemmed from his ability to forge a paper based pilot certificate from the Federal Aviation Administration. This certification relied on a trusted third party (the FAA) that made it relatively difficult for other pilots or employees of Pan-Am to quickly verify Frank's certificate. This allowed him to remain undetected for several years as he flew around the globe (by deadheading). While this particular story does not have any great adverse consequences attached to it (e.g., other than Pan-Am financing Mr. Abagnale's global traveling), such issues may led to real problems in other circumstances—especially in today's world of increasing air traffic and demand for trained pilots.

The paper-based system that existed in the 1960s is similar to the paper system currently used by airlines and government regulators like the FAA. A problem with this system is so-called “fake” pilots. According to recent FAA data, out of about 100,000 licensed commercial pilots there are on average 4 pilots detected per year that are not qualified to carry passengers. If a more accurate monitoring system had been available, then this figure may increase (e.g., as more fake pilots are identified and barred from operating an aircraft). Certificate fraud is an even greater problem in other countries where, by some measures, over half of the listed commercial licenses are under investigation for fraud.

The problem of fraudulent certificates will only increase in the coming years as the demand for airline pilots is set to grow to over 500,000 pilots. The current paper based systems are ill equipped to handle this global increase because the current system lacks the ability to properly, quickly, and easily prove the authenticity of a given certificate. This includes an inability to trust the identities associated with the certificate (e.g., the issuer of the certificate, the trainee (the pilot), and the signees of the certificate), and the inability to trust the transaction that is represented by the certificate (e.g., that the content of the certificate in question is free of tampering between the time of issuance to the time of verification).

Given these and other issues new techniques in this area are sought after.

Certain example embodiments provide a system that satisfies one or more (e.g., all) of the following requirements. The system may allow for the identity of the issuer and of the bearer to be instantly (e.g., within seconds or minutes) verified by a verifying entity. Second, the system may provide proof of credentials. In other words, the training records of the bearer may be instantly verified by the verifier. Third, the system may provide for verification without relying on a trusted 3rd party so that verification only needs the bearer of the certificate and the verifier of the certificate. Fourth, the system may provide for the ability to verify a certificate with a smart phone with a digitalized certificate. Fifth, the system may provide such verifications without relying on any dedicated infrastructure.

In certain example embodiments, an issuer computer system is coupled to one or more computing nodes that host a distributed ledger (a blockchain). The issuer computer system interfaces with the blockchain to record flight & maintenance crew (e.g., aircraft personnel) certifications without relying on the existence of a trusted 3rd party (e.g., such as a signature service system). A verifier computer system is also coupled to one or more of the computing nodes that host the blockchain. The verifier computer system is configured to interface with the blockchain to verify credentials of aircraft personnel. The recordation and verification occurs without the need to rely on a third party that is trusted by the issuer, the bearer of the credentials, and the verifier.

In certain example embodiments, a system for issuing or verifying certifications for aircraft personnel is provided, the system includes an issuer blockchain computer node of a distributed blockchain computer system that also includes other blockchain nodes controlled by other entities that validate aircraft personnel certifications that are stored with a blockchain of the distributed blockchain computer system, the issuer blockchain computer node including at least one hardware processor. The system also includes an issuer computer system that includes at least one processor. The issuer computer system is then configured to (e.g., programmed) to receive personal data for a first person that is taking a first certification program for an aircraft for which the first certification program applies. Upon successful completion of the first certification program by the first person, the issuer computer system is used to authenticate an approver digital identity that is used for certifying completion of the first certification program by the first person. Also the issuer computer system is configured to, in response to certification approval by the approver digital identity, communicate at least the personal data and course data to the at least one blockchain computer node. The issuer blockchain computer node configured to generate a blockchain transaction based on the personal data and the course data and digitally sign the generated blockchain transaction based on the approver digital identity. The issuer blockchain computer node propagates the generated and digitally signed transaction to other nodes of the distributed blockchain computer system for incorporation into the blockchain.

The issuer computer system may include a database system configured to store progress for the first person taking the first certification program. The system may operate whereby different blockchain transactions are generated by the issuer blockchain computer node based on the progress of the first person taking the first certification program.

The issuer computer system may by further configured to, in conjunction with authentication of the approver digital identity, receive approval input for approving successful completion of the first certification program for the first person.

The system may further include a smart card that stores the approver digital identity of an associated approver user.

The system may further include at least one verification blockchain computer node that is one of the other blockchain nodes of the blockchain computer system. The least one verification blockchain computer node may be configured to receive, from another computer system, search criteria related to a subject to be verified, and retrieve personal data and course data from the blockchain of the blockchain computer system based on the search criteria.

The at least one verification blockchain computer node is further configured to validate the subject to be verified based on the retrieved personal and course data.

The blockchain transaction that is generated may include a programmatic structure that includes the personal and course data. The programmatic structure may further cause or be programmed to automatically determine certificate expiration.

The system may further include at least one verification blockchain computer node that is one of the other blockchain nodes of the blockchain computer system. The least one verification blockchain computer node configured to receive a certification identifier, retrieve, based on the certification identifier, search results from the blockchain of the blockchain computer system, and determine the validity of the certification identifier based on the search results.

In certain examples, a system for verifying the validity of aircraft personnel certifications is provided. The system includes a verifier blockchain computer node of a distributed blockchain computer system that also includes other blockchain nodes controlled by other entities including an entity that issues certifications for aircraft personnel, the aircraft personnel certifications being stored with a blockchain of the distributed blockchain computer system, the verifier blockchain computer node including at least one hardware processor and electronic data storage configured to store a portion or all of the blockchain, wherein individual blockchain transactions that are part of the blockchain include personal and program data on the certifications for individual aircraft personnel. The system also may include a verification computer system that includes at least one processor where the verification computer system is configured to receive a name for person of inquiry and a certification reference identifier, transmit a request to the verifier blockchain computer node that includes the name and the certification reference identifier, and receive a digital blockchain certificate based on the transmitted request.

The verification computer system may be a mobile device. The verifier blockchain computer node may be further configured to determine integrity of the stored certificate data.

The verifier blockchain computer node may be further configured to transmit a verification result to the verification computer system that is subsequently displayed to a user of the verification computer system.

In certain example embodiments, a method of issuing or verifying certifications for aircraft personnel using a distributed blockchain computer system that includes at least an issuer blockchain computer node operated by a first entity that issues aircraft certifications to aircraft personnel and a verifier computer node operated by a second entity that validates certifications for aircraft personnel, the distributed blockchain computer system storing, on respective computer nodes, a blockchain. The method includes receiving personal data for a first person that is taking a first certification program for an aircraft for which the first certification program applies; and upon successful completion of the first certification program by the first person, authenticating an approver digital identity that is used for certifying completion of the first certification program by the first person. The method may also include in response to certification approval by the approver digital identity, communicating at least the personal data and course data to the at least one blockchain computer node; and generating a blockchain transaction based on the personal data and the course data. The method may further include digitally signing the generated blockchain transaction based on the approver digital identity; and propagating, from the issuer blockchain computer node, the generated and digitally signed transaction to other nodes of the distributed blockchain computer system for incorporation into the blockchain.

In the method, the certificate issuer computer system may include a database system configured to store progress for the first person taking the first certification program.

The method may further include in conjunction with authentication of the approver digital identity, receiving approval input for approving successful completion of the first certification program for the first person.

The method may further include, at the verification blockchain computer node: receiving, from another computer system, search criteria related to a subject to be verified, and retrieving personal data and course data from the blockchain of the blockchain computer system based on the search criteria.

In the method, the generated blockchain transaction may include a programmatic structure that includes the personal and course data.

In the method, the programmatic structure is further programmed to automatically determine certificate data expiration.

This Summary is provided to introduce a selection of concepts that are further described below in the Detailed Description. This Summary is intended neither to identify key features or essential features of the claimed subject matter, nor to be used to limit the scope of the claimed subject matter; rather, this Summary is intended to provide an overview of the subject matter described in this document. Accordingly, it will be appreciated that the above-described features are merely examples, and that other features, aspects, and advantages of the subject matter described herein will become apparent from the following Detailed Description, Figures, and Claims.

### BRIEF DESCRIPTION OF THE DRAWINGS

These and other features and advantages will be better and more completely understood by referring to the following detailed description of example non-limiting illustrative embodiments in conjunction with the drawings of which:

FIG. 1 illustrates an aircraft that may be operated by aircraft personal according to certain example embodiments;

FIG. 2 is a system block diagram showing example issuer and verifier computer systems that are both coupled to a blockchain computer system according to certain example embodiments;

FIG. 3 is a flowchart showing an example process of issuing and verifying certifications according to certain example embodiments;

FIG. 4 is a function block diagram of an example node in a distributed ledger computer system according to certain example embodiments;

FIG. 5 is a diagram illustrating how a certificate is issued by the issuer computer system to the blockchain and then later verified by the verifier computer system according to certain example embodiments;

FIGS. 6 and 7 illustrate alternative techniques for signing and verifying credential documents; and

FIG. 8 shows an example computing device that may be used in some embodiments to implement features described herein.

### DETAILED DESCRIPTION

In the following description, for purposes of explanation and non-limitation, specific details are set forth, such as particular nodes, functional entities, techniques, protocols, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail.

Sections are used in this Detailed Description solely in order to orient the reader as to the general subject matter of each section; as will be seen below, the description of many features spans multiple sections, and headings should not be read as affecting the meaning of the description included in any section.

Recently, blockchain technology (sometimes simply referred to as a blockchain) has been developed. This technology has been used in digital currency implementations and is described in a 2008 article by Satoshi Nakamoto, called “Bitcoin: A Peer-to-Peer Electronic Cash System,” the entire contents of which are hereby incorporated by reference. A blockchain is a distributed public ledger computer system that records transactions between a source identifier and a destination identifier. These identifiers are created through cryptography such as, for example, public key cryptography. For example, a user may create a destination identifier based on a private key. The relationship between the private key and the destination identifier provide some “proof” that a particular user is associated with the output for a recorded transaction. Certain example embodiments of this application incorporate blockchain technology to provide recordation and verification of aircraft personnel credentials.

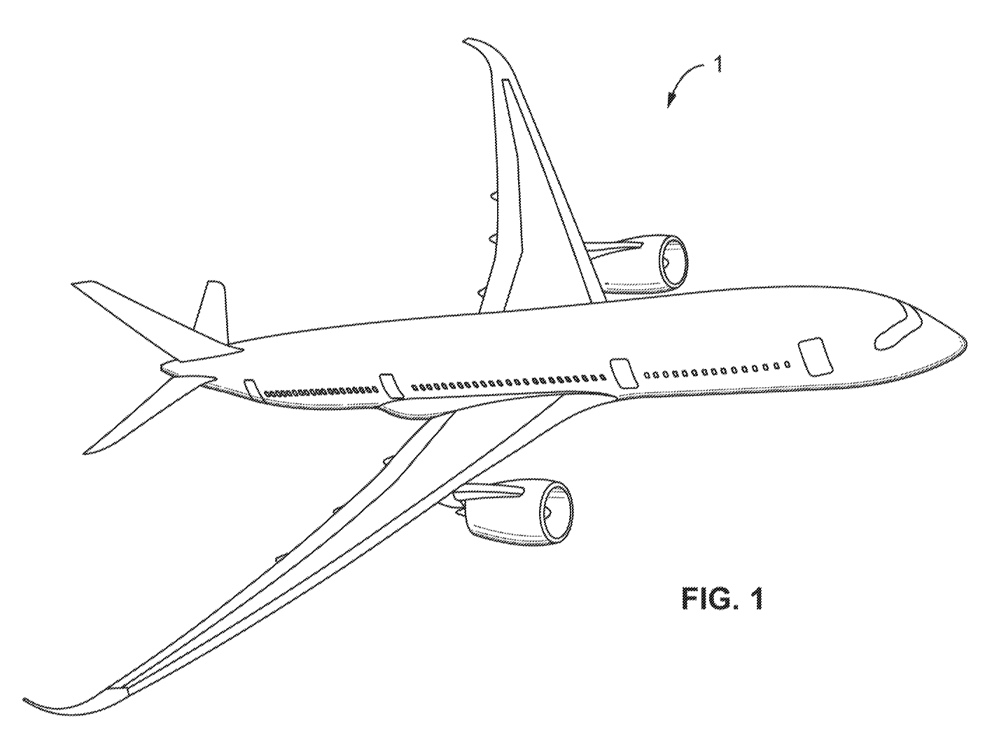

### Description of FIG. 1:

FIG. 1 illustrates an example aircraft 1 operated by one or more pilots. Aircraft 1 may also be operated on by one or more maintenance personnel. As used herein, aircraft personnel includes pilots for an aircraft, maintenance personnel, and other individuals that work with or on aircraft 1. The techniques discussed herein provide for verifying credentials that are held by aircraft personnel. For example, a pilot may be credentialed to operate an Airbus A350, but not an Airbus A320. The examples provided herein may allow for quick verification that a person is or is not properly credentialed or authorized to operate aircraft 1. In certain examples, operation of aircraft 1 by a person (e.g., by a pilot) may be conditioned on authentication and verification of credentials associated with the person. If the credentials are valid for the person for the aircraft in question then the person may then be authorized to work with or on the aircraft. If the credentials presented by the person are deemed invalid or fraudulent, then the person may be barred from operating on or with the aircraft 1.

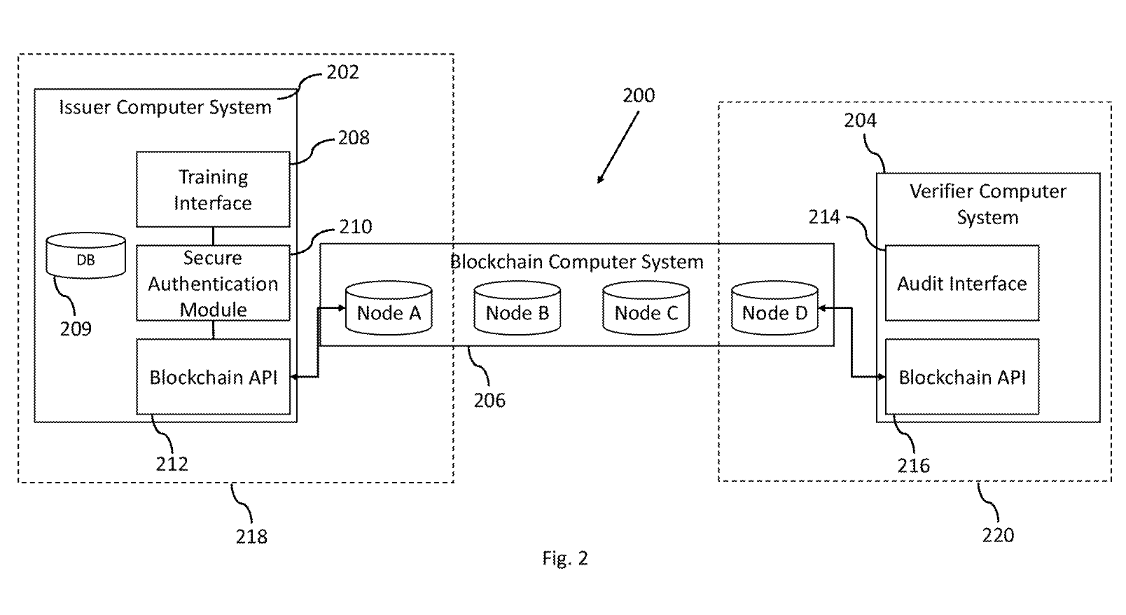

### Description of FIG. 2

FIG. 2 is a system block diagram showing example issuer and verifier computer systems that are both coupled to a blockchain according to certain example embodiments.

Certification system 200 is a distributed computer system that includes an issuer computer system 202, a verifier computer system 204, and a blockchain computer system 206.

Issuer computer system 202 includes a training interface module 208, a secure authentication module 210, and a blockchain application programming interface (API) module 212 that interfaces with at least node A that is part of blockchain computer system 206.

The issuer computer system 202 may host functionality to manage authentication to that system via, for example, database 209. Database 209 may store data in a flat file (e.g., a text file), a structured file (e.g., an XML file), a relational database system (e.g., a SQL database), or the like. Database 209 may also store certificate information for aircraft personnel that are going through training.

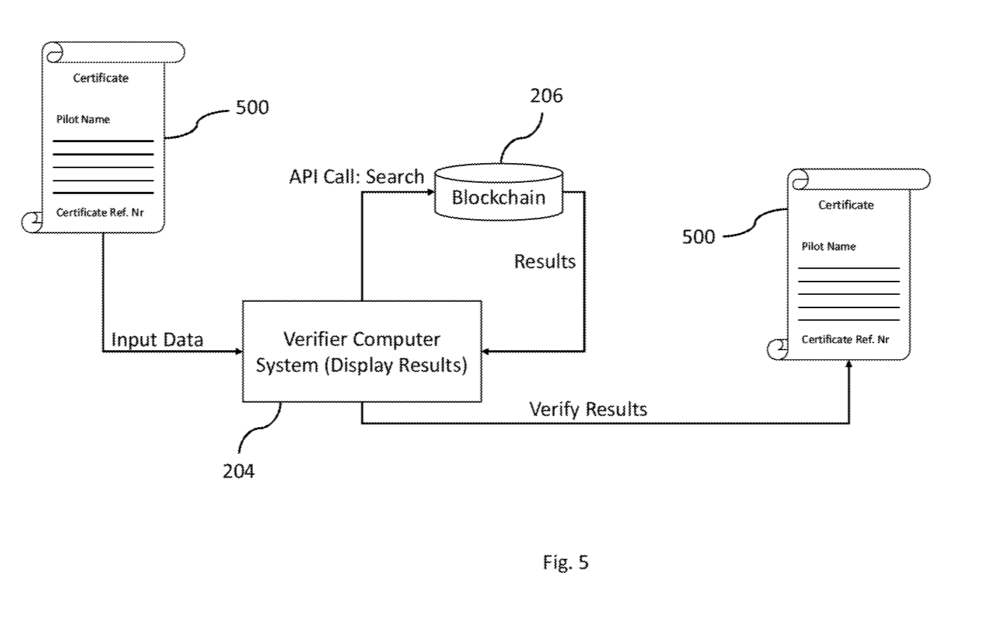

Training interface 208 includes functionality for allowing users (e.g., instructors) of issuer computer system 202 to authenticate against system 202 and enter data (e.g., as described in connection with FIGS. 2 and 5) related to training certificates. For example, training interface 208 may provide functionality for accepting a scanned or electronic version (e.g., a copy of a paper version) of a pilot certificate (or other type of certification). This data may be stored in database 209. Data related to the certificate may be stored in association with the certificate. For example, the name of a pilot, the certification issuance date, the type of certification (e.g., a course type related to an Airbus A350), certification reference number (e.g., a license number), the airline that the pilot is working for, the start date of the course, and/or other information may be stored in database 209. This information may be stored separately (e.g., within individual fields of the database) from the electronic version of the certificate. In certain example embodiments, the electronic version of the certificate is converted into this underlying information and the electronic copy (e.g., that may have been scanned) is discarded. In other words, the information in the document may be extracted (e.g., via OCR or other means) and stored in database 209.

Training interface 208 may also be used by course instructors or others to certify or provide updates to certificates stored with issuer computer system 202. For example, a training instructor may progressively record updates to a trainee's certificate as portions and/or different courses are completed.

In certain example embodiments, training interface 208 includes functionality provided at a server computer and a client computer that is in electronic communication with the server. For example, a training instructor may use and enter information into issuer computer system 202 via a training application being executed on a mobile device used by the instructor. Mobile devices include laptops, tablets, mobile phones, or other portable computing devices. In certain examples, the training interface 208 may include a website that is accessible from standard internet browser applications.

In certain examples, the issuer computer system 202 may be a mobile device that directly communicates with blockchain computer system 206 (or Node A that is a part of thereof).

Secure authentication module 210 includes functionality for authenticating users to issuer computer system 202. Such authentications may be based on an appropriate username/password combination or usage of a smartcard that is assigned to the authenticating user. In certain examples, a smart card used by the authenticating user may also contain a private/public key combination. These keys may be used to digitally sign aircraft personnel certifications that are issued with or stored by issuer computer system 202. This authentication process allows only those that are authorized to access the issuer computer system 202 and thus provide validation for certificates that are stored on the blockchain of the blockchain computer system 206.

Blockchain API 212 includes functionality for interacting with the blockchain (e.g., the distributed ledger) that is part of blockchain computer system 206. In certain examples, this API may include functionality for communicating with a particular node on of blockchain computer system 206. In certain examples, this authentication may include authenticating against a specific node of the blockchain. As shown in FIG. 2, issuer computer system, via blockchain API 212 communicates with a dedicated computing node “A” that is part of the blockchain computer system 206. Each node of blockchain computer system 206 may store the entire blockchain (or a portion thereof). Issuer computer system 202 and computing node “A” may be controlled by the same entity 218. For example, an aircraft manufacturer for airplanes that provides pilot training for aircraft that it produces may control or provide the computing resources that are part of organization 218 (just as organization 220 encompasses the indicated resources in FIG. 2).

In certain examples, different providers or issuers of aircraft certificates (e.g., different aircraft manufactures) may interface with blockchain computer system 206. In certain examples, each of the different issuers maintains their own issuer computer system and may control or have their “own” computing node that is part of the blockchain computer system 206. Each issuer may thus interface with the broader blockchain computer system 206 via the respective nodes that they control. Access to individual nodes may be controlled via standard authentication techniques (e.g., to prevent third parties from submitting requests to nodes that are responsible for handling newly issued aircraft personnel certificates).

In certain examples, when a certificate is ready to be signed (e.g., upon a pilot completing a program and the one or more courses therein) the document signer will authenticate against issuer computer system 202. Such authentications are controlled by secure authentication module 210 (e.g., via a username/password combination). Once authenticated, the user may then validate the certificate. Once the certificate is validated, issuer computer system 202 may use blockchain API 212 to interface with blockchain computer system 206.

As briefly discussed above, a blockchain is a distributed ledger technology that operates with transactions that are formed from a source identifier to a destination identifier. The blockchain is thus a data structure that is maintained across the computing nodes that makeup the blockchain computer system 206. Validation of the transactions that are incorporated into the blockchain may be accomplished using one or more of a variety of different consensus techniques. Such techniques or protocols include, for example, proof of work, practical byzantine fault tolerance (PBFT), proof of importance, proof of stake, proof of elapsed time, and other consensus protocols.

In certain example embodiments, the proof-of-work consensus technique is used. With this technique, multiple different computer nodes each operate to “mine” and thereby validate transactions submitted to the blockchain. Generally, only one of the nodes needs to “receive” a transaction that has been submitted from a client (a client to the blockchain may be, for example, issuer computer system 202). Once one node receives a transaction it may propagate the transaction to other nodes within the blockchain computer system 206 (or one node may generate a transaction and publish it to other nodes).

Each transaction (or a block of transactions) is incorporated/included into the blockchain of the blockchain computer system 206 via a proof-of-work mining process. The mining process may involve solving a computationally difficult problem that is also easy to verify. For example, each node may attempt to “mine” a solution to the hash of a block or a transaction. Hashes (also referred to herein as “hash functions,” “cryptographic hash functions,” and the like) include functions that map an initial input data set to an output data set. The output from a hash function may be referred to herein as a “hash identifier,” “hash value,” “hash data set,” or simply, a “hash”. Generally, the output values from a given hash function have the same fixed length. If the same hash function is used on the same input data it will typically result in the same output data value. With some hash functions (including those used in the context of blockchain techniques and/or the subject matter of this application) the input value is computationally difficult to determine when only the output value is known. In certain examples, the input value for the hash function is supplemented with some additional random data. For example, an input value of the string “blockchain” for a hash function may include addition random data such as three random characters. Accordingly, the data value that ends up being hashed may be “blockchaina5h” instead of simply “blockchain.” The additional random data is sometimes called a “nonce.”

In order to validate a new block or transaction that is to be incorporated into the blockchain, the proof of work process (or hash operation process) that is performed may include finding an input hash value (i.e., the block) that results in an output hash value that meets a given condition. When a block of transactions (or a transaction) is ready to be included in the blockchain the nodes of the chain work to find the “nonce” that results in a predetermined hash value. As the data related to the block (or transaction) is fixed across the nodes (e.g., all nodes are attempting to find the answer to the same problem), the miners (e.g., nodes on the blockchain) modify the nonce value that is included as part of the block being validated until the output value of the hash function meets the given condition. For example, a target output value may have 5 zeros as the first four numbers of the hash. This is a problem that may be computationally difficult to determine, yet relatively easy to verify.

In certain example embodiments, a PBFT consensus protocol may be used. In certain examples, when a transaction is submitted for incorporation into the blockchain, a node in the blockchain computer system 206 may be selected at random. In other examples, the node may be preselected (e.g., a node that is controlled by a certificate issuer). The selection of such a node may be based on the relative level of trust the entity that is submitting the transaction has to the node. In other words, nodes with high trust levels may be favored for selection. In any event, once the selected node receives the transaction it may be validated by that node. The validating node may then issue a command or message to other nodes in the blockchain computer system 206 to add the transaction to their respective databases (e.g., the blockchain data structure). Thus it will be appreciated that the techniques herein may use different types of consensus protocols in order to validate transactions for the blockchain.

In certain example embodiments, the different nodes of the blockchain computer system 206 may be controlled by different entities that are interested in issuing and/or verifying aircraft personnel credentials. The various entities may include: 1) aircraft manufactures (e.g., Airbus, Boeing, Bombardier, etc. . . . ); 2) independent pilot training organizations; 3) Government Regulatory Bodies (e.g., the European Aviation Safety Agency or EASA, the Federal Aviation Administration or FAA), and 4) Airlines (e.g., Air France, Delta, Emirates, etc. . . . ). Generally each of these entities owns, controls, or is responsible for their own blockchain chain node (e.g., Node B), and front-end application interfaces for interfacing with the blockchain (e.g., like issuer computer system 202). Each application used by the various entities may then directly interact with the blockchain via API calls (e.g., by generating and submitting blockchain transactions to the blockchain).

The blockchain computer system 206 thus provides integrity for the data that is stored thereon (e.g., the transactions are effectively tamper proof once stored to the blockchain). Blockchain computer system 206 also allows for non-repudiation because the issue time and date of a given certificate may be verified by downstream users (e.g., those accessing the data via verifier computer system).

Returning to FIG. 1, verifier computer system 204 includes audit interface module 214 and blockchain API module 216. The audit interface module 214 provides a user interface (e.g., via a web page or via a dedicated graphical user interface) for entering and outputting information to users of verifier computer system 204. For example, a user may enter the name of a pilot and retrieve a digital version of the certificates associated with that pilot. As with the training interface module 208, audit interface module may be provided via a combination of client and server software. For example, the client may be an application executed by a mobile device that is communication with a server or the audit interface may entirely operate on a mobile device that is in direct communication with a corresponding blockchain node (via the below noted blockchain API).

The blockchain API module 216 provides an application programming interface for communicating with blockchain compute system 206, or a node thereof. In certain examples, the verifier computer system 204 communicates with a specific node (Node D) that is part of the blockchain computer system 206. Thus, the different computer systems that interface with blockchain computer system 206 may interface with specific nodes of that system. Here, Node 4 and verifier computer system 204 may be all controlled by the same entity or organization (e.g., an airline or regulatory body) as indicated by dashed box 220.

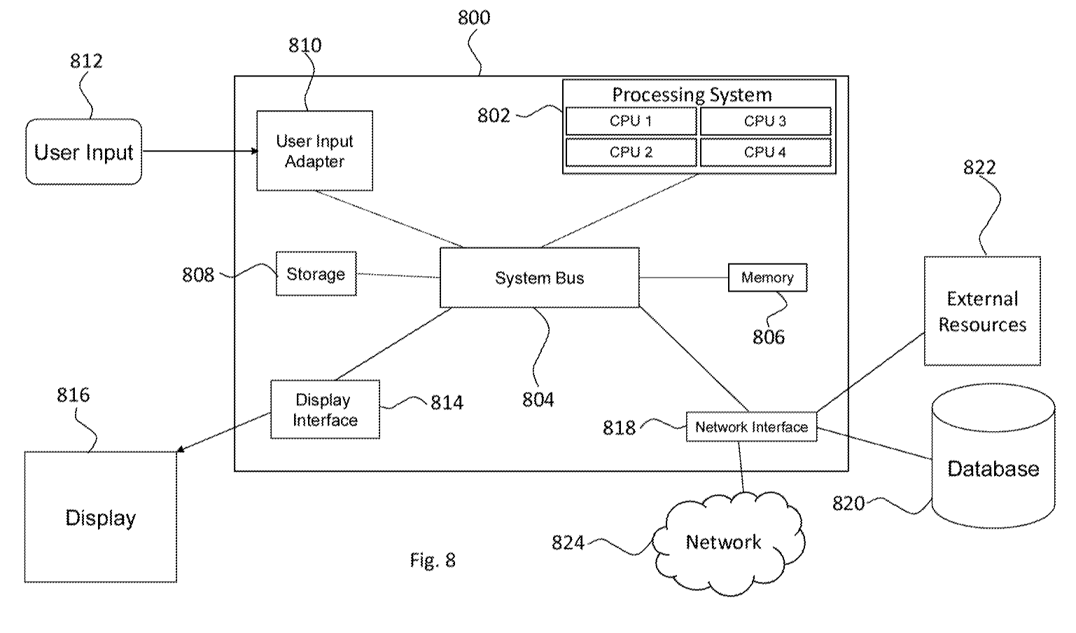

It will be appreciated that the software modules and actions performed by software modules are described in this document. As would be understood by persons of ordinary skill in the art, whenever it is described that a software module (or other element that comprises software instructions) performs an action, that action is in actuality performed by underlying hardware elements (such as a processor and a memory device) according to the instructions that comprise the software module. Further details regarding this are provided below in, among other places, the description of FIG. 8.

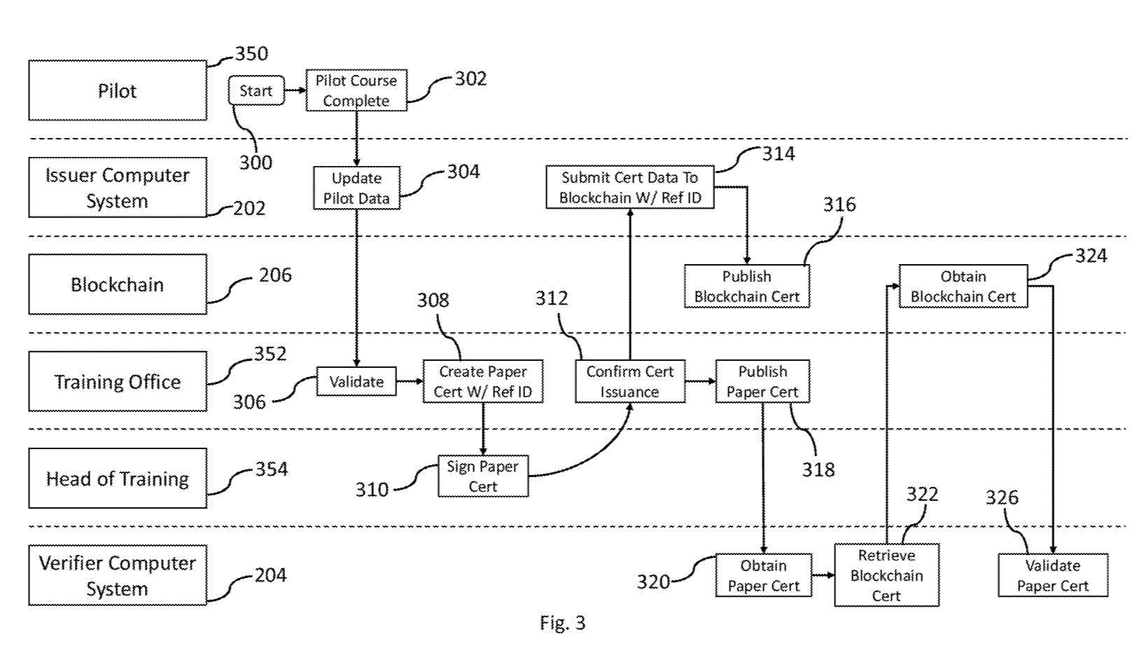

### Description of FIG. 3

FIG. 3 is a flowchart showing an example process of issuing and verifying certifications according to certain example embodiments;

At 300, pilot 350 starts a certification course with an organization. During this time the internal database of the issuer computer system 202 operated by the flight training organization may be populated with information on the pilot (e.g., Age, Airline, Aircraft being certified, etc. . . . ).

At 302, the pilot 352 completes the certification course. At 304, the issuer computer system 202 is used to update the pilot data. In certain examples, the pilot information may be initially entered at this point in the process. In certain examples, the data that is updated may occur automatically in connection with the pilot completing the program.

At 306, a training office 352 validates the training information for the pilot (e.g. that is stored in the internal database of the issuer computer system 202). This may include reviewing test scores or other metrics to ensure that the individual in question has properly completed the course or program in question.

At 308, a paper certificate is generated with a certificate reference identifier (e.g., a number, an alpha-numeric string, etc. . . . ). Generally, the certificate reference number is a unique identifier (e.g., a globally unique identifier) that uniquely identifies a given certificate amongst all other past, current, or future certificates.

At 310, the head of training for the certificate training program signs the paper certification indicating that the pilot in question is now credentialed as indicated on the paper certificate. In certain examples, the head of training (or representative thereof) may also electronically approve the certificate that is digitally stored in database 309. In response to this approval, an API call is triggered that submits the meta data of the certificate to the blockchain node coupled to the issuer computer system 202.

At 312, the training office confirms issuance of the paper certificate and that the head of training has properly signed the paper certificate.

At 314, the issuer computer system 204 submits the certification data to the blockchain computer system 206 for incorporation into the blockchain. Included in the submitted data is the certificate reference identifier (e.g., the license number) generated by the training office at step 308. In certain examples, the submitted information may include, for example a digital signature of the head of training (e.g., to mimic the physical signing of the paper certificate). In certain examples, the submitted information may include a scanned copy, or a hash of the scanned version of the certificate. The information may be transmitted to the blockchain via blockchain API 212 to a specific node (e.g., Node A) that is part of the blockchain computer system 206.

At 316, the blockchain computer system 206 receives the information, generates a blockchain transaction based on the information, and submits the transaction to the blockchain for recordation therein. For example, the transaction may contain the meta data of the training certificate including the name of the bearer (e.g., the pilots name), the issuer (e.g., Airbus), the issuer's site, the date of the issue, and the name of the training course, and other information contained on the certificate.

The generated transaction may be signed with the digital identity of the person who approved the pilot's certificate (e.g., at 310). In certain examples, this digital identity may be provided by a smart card that is carried by the approving user (e.g., that is retrieved via the secure authentication module 210). The generated and signed blockchain transaction is then propagated to other nodes for subsequent incorporation into the blockchain.

The other nodes in the blockchain computer system may receive the proposed transaction of the certificate and independently validate that the transaction is legitimate in a sense that the transaction is not a counterfeit, and that it has been the first time this blockchain transaction was received in the history of the system 200.

As described herein, the process of validating the transaction may include a proof-of-work process or other consensus process (e.g., PBFT). In certain examples, multiple transactions may be combined into a block of transactions. In certain examples, each transaction may be validated individually. The digital version of the certification may thus be published to the blockchain of the blockchain computer system.

Only upon the nodes (e.g., all, the majority, trusted nodes, etc. . . . ) reaching a consensus will the transaction be viewed as legitimate and be considered official. In certain examples, the recordation of the transaction in the blockchain includes recording a transaction time using the using the average time of the time stamp of the each node of the blockchain compute system 206.

At 318, separately from the electronic process and interaction with the blockchain, the paper certificate is published.

At 320, a verifying entity (e.g., a regulatory body or an airline) may use verification computer system 204 to confirm the authenticity of a paper certificate. For example, pilot 350 may be asked to present their certificate upon a request by a regulatory body (e.g., the FAA). Data from the certificate may be entered into the verifier computer system 204 (e.g., via audit interface 214).

At 322, the verifier computer system 204 may use the blockchain API to request data for the certificate of interest. This may include generating a request that is submitted to the blockchain computer system 206 to retrieve certificate information for the pilot with the name listed on the certificate for the certificate reference identifier listed on the paper certificate.

At 324, the blockchain computer system 206 (e.g., via node D that is coupled to the verifier computer system 204) looks up the certificate information for the pilot for that certificate reference identifier. In certain example embodiments, node D of the blockchain computer system 206 may determine whether or not the information provided from the paper certificate is valid by comparing it to the certificate information published to the blockchain at step 316.

At 326, a result of the verification is reported to the verifier computer system. This may include a notification that the paper certificate is valid or that it is invalid.

In certain example embodiments, a verifier (e.g., airlines and authorities) can log into their local node of the blockchain computer system 206 through their own API (including mobile applications). This may be accomplished using a local user authentication system and/or an authentication system provided by the blockchain computer system (or the node). Once authenticated, the user can search the local node (e.g., because each node contains a copy of the blockchain) for the Flight/Maintenance training certificate by the issue number (e.g., the unique reference number), the name of the bearer, or the like. In certain examples, the search by may be triggered by using Near Field Technology such as QR code to scan the code of a paper certificate. The QR code may contain or be the certificate reference identifier. The blockchain computer system 206 then locates the certificate that is stored in the blockchain. Once identified, the blockchain computer system (or a node thereof) checks the total integrity of the certificate. For example, that the original certificate as issued by the issuer (e.g., Airbus) has not been tampered with in anyway. The node then returns a response to the user (or computer being used by the user) that the certificate the user is seeing is fully original and not tampered with.

As shown above, the paper and blockchain based certificates are both valid and each paper certificate that is generated has a blockchain counterpart.

In certain examples, the certificate data that is generated and stored to the blockchain may be correspondingly stored to a pilot certificate cart or other electronic medium (e.g., a mobile phone). In such an example, this may replace the paper-based certificate. Accordingly, the information stored on this device (e.g., a mobile phone of the pilot) may be used at the basis for the validation performed by the verifier computer system 204.

In certain examples, an example training and certificate process may operate as follows. A pilot that wishes to be certified for specific type of aircraft enrolls in a training process (e.g., that is provided by an aircraft manufacturer).

The training office for the certification program starts the process and enrolls the pilot in the training program on the blockchain (e.g., via the issuer computer system 202). The pilot profile may then become available for a first course and become available for Synthetic Flight Training Instructor (SFI). The pilot then travels to a first training location and starts the Synthetic Flight Training Course.

Upon completing of Synthetic Flight Training, the training instructor logs into the issuer computer system and/or the blockchain and enters the required information for the pilot and marks the training as successfully completed for that pilot.

After completion of SFI, the pilot profile becomes available for a Type Rating Instructor (TRI). Pilot travels to second training location and starts Type Rating Training Course.

The pilot subsequently completes Type Rating Training. The Training instructor (TRI) logs into the issuer computer system 202 and enters the required information and marks the training as successfully completed.

After completion of TRI, the pilot profile becomes available for Type Rating Examiner (TRE). Pilot travels to third training location and starts second Type Rating Training Course.

Pilot completes second Type Rating Training and the Training Examiner (TRE) logs into the issuer computer system 202 to enter the required information. The training is marked as successfully completed and a Training Office is alerted of the completed trainings.

In certain example embodiments, the completion of each course for the various instructors (SFI, TRI, TRE) is recorded to the blockchain as a separate transaction. In other words, the workflow that is performed by the pilot proceeding through different courses for certification may also be recorded to the blockchain. The multiple different generated blockchain transactions may include, for example, a first transaction that is initiated upon registration of the pilot to the training program. A second blockchain transaction may be “to” the SFI. A further blockchain transaction (e.g., upon completion of the course) may be from the SFI to the TRI. Upon completion of the course with the TRI, another transaction may be generated to the TRE from the TRI. In certain examples, upon approval or successful completion of the relevant course the instructor may “sign” the transaction to thereby indicate that the course has been completed for this pilot. Each instructor (or course) may have its own associated private key/public key pair.

In certain example embodiments, the workflow (e.g., the different course taken by the pilot) may be stored off the blockchain and in the database 209 of the issuer computer system 202.

Upon completion of the course with the TRE, another blockchain transaction could be “to” the head of training (or the training office). Thus, when the Training Office logs into the issuer computer system 202, he may double check and verify that the training is complete. The training office then forwards the pilot profile to the Head of Training (HoT) or Head of Training representative. The Head of Training or representative logs into the issuer computer system 202 (or the blockchain) and digitally signs the pilot certificate. The pilot certificate, along with relevant training information, becomes available (e.g., almost instantly) on the blockchain to relevant airlines and authorities for verification and auditing purposes.

In certain examples, completion of individual courses in a certification program may be recorded to the blockchain and/or may be recorded to an internally database of the issuer computer system 202.

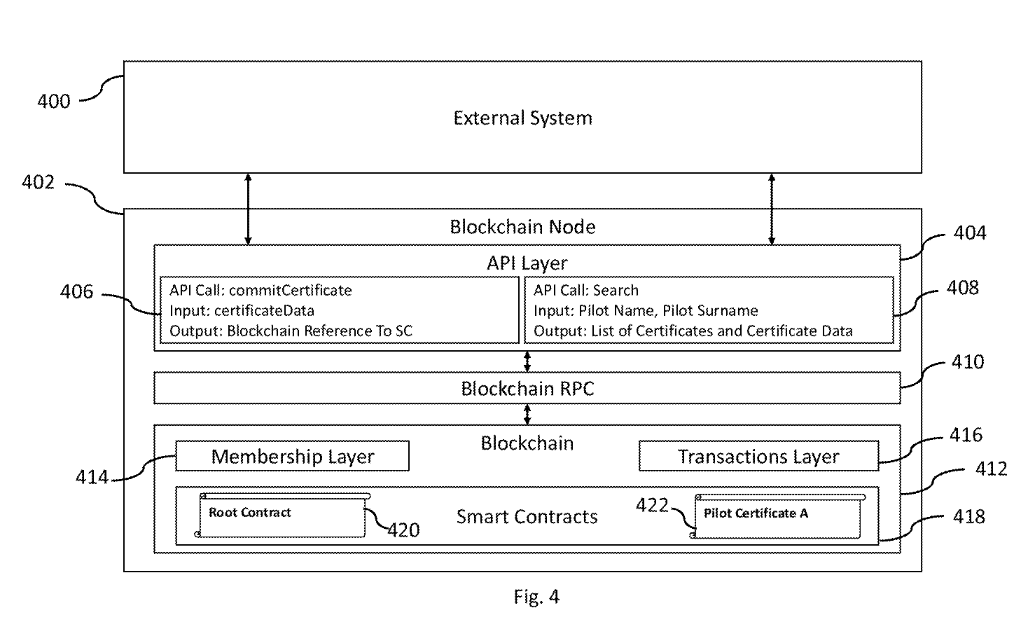

### Description of FIG. 4

FIG. 4 is a function block diagram of an example node in a blockchain computer system according to certain example embodiments.

External system 400 includes those computer systems that interface with blockchain computer system 206 and/or computing nodes of that system (e.g., Nodes A, B, C, D, etc. . . . ). For example, external system 400 may be issuer computer system 202 or verifier computer system 204.

Blockchain node 402 is an example computing node that is part of the blockchain computer system 206. Generally, each entity that is interfacing with the blockchain may maintain and/or be responsible for their own node. Node 402 is responsible for interfacing with the blockchain (the distributed ledger) that is stored across the blockchain computer system 206. Accordingly, blockchain node 402 is an example of Nodes A, B, C, and D shown in FIG. 2.

In certain examples, each blockchain node 402 is processed under a virtual machine (e.g., running Linux, Unix, or other virtual machine instance).

Blockchain node 402 includes an API layer 404, a blockchain remote procedure call (RPC) interface, and a blockchain layer 412.

API layer 404 includes one or more interfaces (e.g., function calls) that are used to retrieve and/or submit information to the blockchain. This includes the commit certificate API call 406 and the search API call 408.

The commitCertificate API call 406 requires certificate data an input and outputs (e.g., returns to the caller) the blockchain reference to the smart contract. The inputs include: 1) the name of the pilot, 2) the license or certificate reference number, 3) the airline name, 4) the court type, 5) the course start date, and/or 6) the certificate issuance date. Naturally, other information may be included as needed. In certain examples, the certificate data is transmitted and stored on the Blockchain without hashing the data (e.g., the data is stored “as is”).

The search API call 408 requires the pilot name and surname and returns a list of certificates and certificate data. This information may be returned to the caller in the form of, for example, an XML file that includes a list of certificates for the searched pilot.

Blockchain RPC 410 includes functionality for forming blockchain transactions and searching for information on the blockchain.

Blockchain 412 is the distributed ledger that is stored in the memory of each node of the blockchain computer system. This includes the transactions 416 that make up the blockchain chain and identity or memberships 414 (e.g., blockchain identifiers) that the transactions are between (e.g., a source and destination identifier). On top of the blockchain are so-called smart contracts 418 that hold the pilot certificate information.

As used herein, smart contracts are computer programs or scripts (e.g., programmatic structures) that are embedded into blockchain transactions and are executed or stored on the blockchain (e.g., distributed system and/or the nodes thereof). A simple example of a smart contract may be software program that automatically sends 10 dollars (or electronic currency) in the form of a blockchain transaction from A (the wallet of A) to B (the wallet of B) when B can run a mile in 6 minutes. In a pilot example, the smart contract may maintain logic that handles the expiration of issued pilot certificates.

Different types of smart contracts that are included may be a root contract that stores a list of pilot certificates by Pilot ID. In certain examples, this contract is updated when a new pilot is certified and/or when a pilot's certification expires. Another smart contract may be for individual pilots this may include the following information: 1) “pilot_last_name”; 2) “pilot_first_name”; 3) “pilot_date_of_birth”; 4) “pilot_license_ID”; 5) courses”: [list of courses], etc. . . . .

The pilot smart contract may also include logic to automatically check for certificate expiration. In certain example embodiments, this may trigger a notice (e.g., an email or the like) to the pilot or other relevant entities (e.g., a regulatory body, an airline, or the entity that originally certified the pilot).

### Description of FIG. 5

FIG. 5 is a diagram illustrating how a certificate may be verified by the verifier computer system 204 according to certain example embodiments.

The validity of a paper based certificate 500 can be verified by obtaining the Pilot Name and Certificate Reference Number from the paper certificate. The obtained information is input via the interface on the verifier computer system (e.g., via a web page or the like). This information triggers a call to the Search API call (see FIG. 4) on the blockchain node. The results of the search are returned to the verifier computer system 204 (e.g., via a web page of the like) and the digital certificate that is stored in the blockchain may be displayed to the requesting user. The certificate that is displayed may include the pilot name, the certified courses for that pilot, along with one or more corresponding certificate numbers.

The requesting user can then verify that the retrieved blockchain certificate matches (or does not match) the paper based certificate. For example, the user can verify that the certificate reference number listed on the paper certificate matches the certificate reference number that is stored on the blockchain.

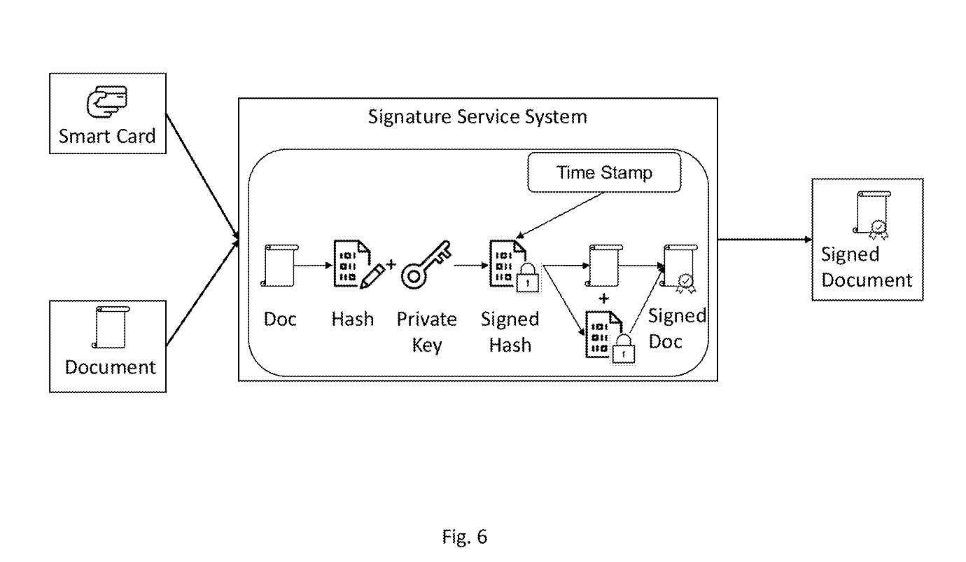

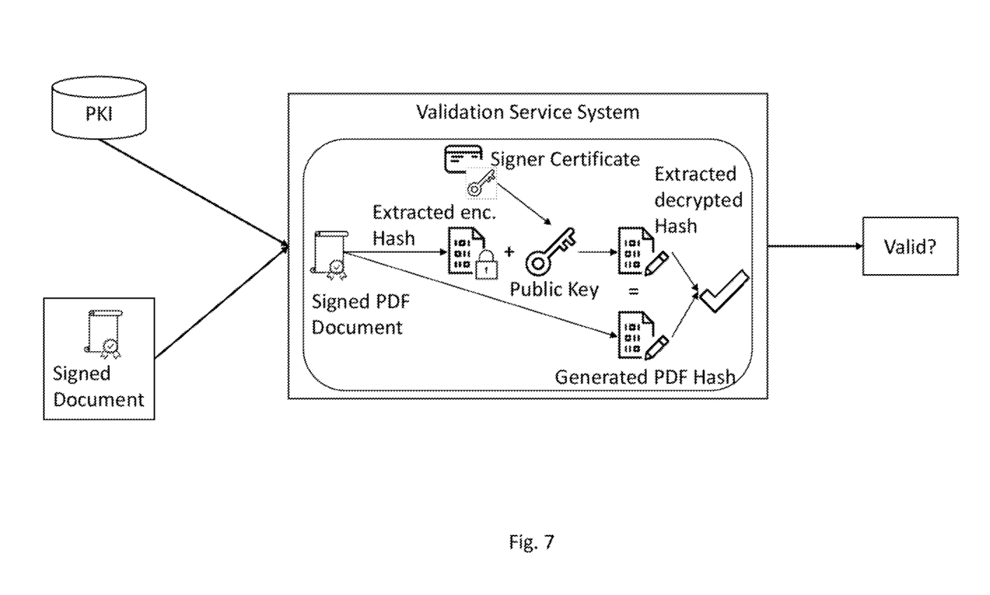

### Description of FIGS. 6 and 7

FIGS. 6 and 7 illustrate alternative techniques for signing and verifying credential documents.

As shown in FIG. 6, an alternative technique for issuing creditionals is shown. The Document signer uses his Smart Card with the signature service (online or offline) to digitally sign a PDF document (and electronic version of the original certificate). During the signing process the signature service generates the hash of the PDF document and encrypts the hash with the document signers private key (obtained from the signer's smart card). Following that the encrypted hash is appended to the PDF document as the document's signature. In this example the signature service is responsible for the non-repudiation and integrity of the certificate. This is in contrast to the blockchain-based technique shown herein.

FIG. 7 shows an alternative for verifying a certificate. Here, the Document Signer sends both the Signed PDF document (e.g. as created in FIG. 6) and his public key certificate to the Document verifier. The document verifier uses the signer's certificate with the validation service to validated the PDF document's authenticity. To validate the PDF document authenticity the validation service extracts the encrypted hash from the document and decrypts it using the public key from the signer's certificate. Next, the hash of the document is generated and compared with the decrypted extracted hash. If both hashes match, then the document is validated. The validation service additionally checks the time stamp correctness and the revocation status of the certificate.

### Description of FIG. 8

FIG. 8 is a block diagram of an example computing device 800 (which may also be referred to, for example, as a “computing device,” “computer system,” or “computing system”) according to some embodiments. In some embodiments, the computing device 800 includes one or more of the following: a processing system 802 that includes one or more processors; a system bus 804 (e.g., to carry data between components of computing device 800), one or more memory devices 806 and storage devices 808; one or more user input adapters 810; one or more network interface devices 818; and one or more display interfaces 814. Additionally, in some embodiments, the computing device 800 is connected to or includes a display device 816, or a user input device 812. As will explained below, these elements (e.g., the processors of processing system 802, memory devices 804, storage devices 808, network interface devices 818, display interfaces 814, user input adapters 810, display device 816) are hardware devices (for example, electronic circuits or combinations of circuits) that are configured to perform various different functions for the computing device 800.

In some embodiments, each or any of the processors of the processing system is or includes, for example, a single- or multi-core processor (e.g., CPU 1, CPU 2, CPU 3, CPU 4), a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors uses an instruction set architecture such as, for example, x86 or Advanced RISC Machine (ARM).

In some embodiments, each or any of the memory devices 806 and/or storage 808 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors of the processing system). Memory and storage devices are examples of non-volatile computer-readable storage media.

In some embodiments, each or any of the network interface devices 818 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In some embodiments, each or any of the display interfaces 814 is or includes one or more circuits that receive data from the processors, generate (e.g., via a discrete GPU, an integrated GPU, a CPU executing graphical processing, or the like) corresponding image data based on the received data, and/or output (e.g., a High-Definition Multimedia Interface (HDMI), a DisplayPort Interface, a Video Graphics Array (VGA) interface, a Digital Video Interface (DVI), or the like), the generated image data to the display device 816, which displays the image data. Alternatively or additionally, in some embodiments, each or any of the display interfaces 814 is or includes, for example, a video card, video adapter, or graphics processing unit (GPU).

In some embodiments, each or any of the user input adapters 810 is or includes one or more circuits that receive and process user input data from one or more user input devices 812 that are included in, attached to, or otherwise in communication with the computing device 800, and that output data based on the received input data to processing system 802. Alternatively or additionally, in some embodiments each or any of the user input adapters 810 is or includes, for example, a PS/2 interface, a USB interface, a touchscreen controller, or the like; and/or the user input adapters 810 facilitates input from user input devices (not shown in FIG. 8) such as, for example, a keyboard, mouse, trackpad, touchscreen, etc. . . . .

In some embodiments, the display device 816 may be a Liquid Crystal Display (LCD) display, Light Emitting Diode (LED) display, or other type of display device. In embodiments where the display device 816 is a component of the computing device 800 (e.g., the computing device and the display device are included in a unified housing), the display device 816 may be a touchscreen display or non-touchscreen display. In embodiments where the display device 816 is connected to the computing device 800 (e.g., is external to the computing device 800 and communicates with the computing device 800 via a wire and/or via wireless communication technology), the display device 816 is, for example, an external monitor, projector, television, display screen, etc. . . . .

In various embodiments, the computing device 800 includes one, or two, or three, four, or more of each or any of the above-mentioned elements (e.g., the processor systems 802 and/or processors thereof, memory and storage devices 806 and 808, network interface devices 818, display interfaces 814, and user input adapters 810). Alternatively or additionally, in some embodiments, the computing device 800 includes one or more of: a processing system 802 that includes CPUs 1, 2, 3, and/or 4; a memory or storage system that includes the memory devices 804 and/or storage devices 808; and a network interface system that includes the network interface devices 818.

The hardware configurations shown in FIG. 8 and described herein are provided as examples, and the subject matter described herein may be utilized in conjunction with a variety of different hardware architectures and elements. For example: in many of the Figures in this document, individual functional/action blocks are shown; in various embodiments, the functions of those blocks may be implemented using (a) individual hardware circuits, (b) using an application specific integrated circuit (ASIC) specifically configured to perform the described functions/actions, (c) using one or more digital signal processors (DSPs) specifically configured to perform the described functions/actions, (d) using the hardware configuration described above with reference to FIG. 8, (e) via other hardware arrangements, architectures, and configurations, and/or via combinations of the technology described in (a) through (e).

As used herein, the term “non-transitory computer-readable storage medium” includes a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or Blu-Ray Disc, or other type of device for non-transitory electronic data storage. The term “non-transitory computer-readable storage medium” does not include a transitory, propagating electromagnetic signal.

Although process steps, algorithms or the like, including without limitation with reference to FIGS. 3 and 4, may be described in a particular sequential order, such processes may be configured to work in different orders. In other words, any sequence or order of steps that may be explicitly described or claimed in this document does not necessarily indicate a requirement that the steps be performed in that order; rather, the steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, element, component, or step in this document is intended to be dedicated to the public.

1. A certification system for issuing or verifying certifications for aircraft personnel, the system comprising:
an issuer blockchain computer node of a distributed blockchain computer system that also includes other blockchain nodes controlled by other entities that validate aircraft personnel certifications that are stored with a blockchain of the distributed blockchain computer system, the issuer blockchain computer node including at least one hardware processor; and
an issuer computer system that includes at least one processor, the issuer computer system configured to:
receive personal data for a first person that is taking a first certification program for an aircraft for which the first certification program applies,
upon successful completion of the first certification program by the first person, authenticate an approver digital identity that is used for certifying completion of the first certification program by the first person, and
in response to certification approval by the approver digital identity, communicate at least the personal data and course data to the at least one blockchain computer node,
the issuer blockchain computer node configured to:
generate a blockchain transaction based on the personal data and the course data,
digitally sign the generated blockchain transaction based on the approver digital identity, and
propagate the generated and digitally signed transaction to other nodes of the distributed blockchain computer system for incorporation into the blockchain.

2. The certification system of claim 1, wherein the issuer computer system includes a database system configured to store progress for the first person taking the first certification program.

3. The certification system of claim 2, wherein different blockchain transactions are generated by the issuer blockchain computer node based on the progress of the first person taking the first certification program.

4. The certification system of claim 1, wherein the issuer computer system is further configured to, in conjunction with authentication of the approver digital identity, receive approval input for approving successful completion of the first certification program for the first person.

5. The certification system of claim 1, further comprising a smart card that stores the approver digital identity of an associated approver user.

6. The certification system of claim 1, further comprising:
at least one verification blockchain computer node that is one of the other blockchain nodes of the blockchain computer system,
the least one verification blockchain computer node configured to:
receive, from another computer system, search criteria related to a subject to be verified,
retrieve personal data and course data from the blockchain of the blockchain computer system based on the search criteria.

7. The certification system of claim 6, wherein the at least one verification blockchain computer node is further configured to validate the subject to be verified based on the retrieved personal and course data.

8. The certification system of claim 1, wherein the generated blockchain transaction includes a programmatic structure that includes the personal and course data.

9. The certification system of claim 8, wherein the programmatic structure is further programmed to automatically determine certificate expiration.

10. The certification system of claim 1, further comprising:
at least one verification blockchain computer node that is one of the other blockchain nodes of the blockchain computer system,
the at least one verification blockchain computer node configured to:
receive a certification identifier,
retrieve, based on the certification identifier, search results from the blockchain of the blockchain computer system, and
determine the validity of the certification identifier based on the search results.

11. A system for verifying the validity of aircraft personnel certifications, the system comprising:
a verifier blockchain computer node of a distributed blockchain computer system that also includes other blockchain nodes controlled by other entities including an entity that issues certifications for aircraft personnel, the aircraft personnel certifications being stored with a blockchain of the distributed blockchain computer system, the verifier blockchain computer node including at least one hardware processor and electronic data storage configured to store a portion or all of the blockchain, wherein individual blockchain transactions that are part of the blockchain include personal and program data on the certifications for individual aircraft personnel; and
a verification computer system that includes at least one processor, the verification computer system configured to:
receive a name for person of inquiry and a certification reference identifier,
transmit a request to the verifier blockchain computer node that includes the name and the certification reference identifier, and
receive a digital blockchain certificate based on the transmitted request.

12. The system of claim 11, wherein the verification computer system is a mobile device.

13. The system of claim 11, wherein the at least one processor of the verifier blockchain computer node is further configured to determine integrity of the stored certificate data.

14. The system of claim 11, wherein the at least one processor of the verifier blockchain computer node is further configured to transmit a verification result to the verification computer system that is subsequently displayed to a user of the verification computer system.

15. A method of issuing or verifying certifications for aircraft personnel using a distributed blockchain computer system that includes at least an issuer blockchain computer node operated by a first entity that issues aircraft certifications to aircraft personnel and a verifier computer node operated by a second entity that validates certifications for aircraft personnel, the distributed blockchain computer system storing, on respective computer nodes, a blockchain, the method comprising:
receiving personal data for a first person that is taking a first certification program for an aircraft for which the first certification program applies;
upon successful completion of the first certification program by the first person, authenticating an approver digital identity that is used for certifying completion of the first certification program by the first person;
in response to certification approval by the approver digital identity, communicating at least the personal data and course data to the at least one blockchain computer node;
generating a blockchain transaction based on the personal data and the course data;
digitally signing the generated blockchain transaction based on the approver digital identity; and
propagating, from the issuer blockchain computer node, the generated and digitally signed transaction to other nodes of the distributed blockchain computer system for incorporation into the blockchain.

16. The method of claim 15, wherein the certificate issuer computer system includes a database system configured to store progress for the first person taking the first certification program.

17. The method of claim 15, further comprising, in conjunction with authentication of the approver digital identity, receiving approval input for approving successful completion of the first certification program for the first person.

18. The method of claim 15, further comprising:
at the verification blockchain computer node:
receiving, from another computer system, search criteria related to a subject to be verified, and
retrieving personal data and course data from the blockchain of the blockchain computer system based on the search criteria.

19. The method of claim 15, wherein the generated blockchain transaction includes a programmatic structure that includes the personal and course data.

20. The method of claim 19, wherein the programmatic structure is further programmed to automatically determine certificate data expiration.
